(19) United States
(12) Patent Application Publication
(10) Pub. No.: US 2024/0396401 A1
(43) Pub. Date: Nov. 28, 2024

(54) ELECTRIC MACHINE WITH ONE HOUSING

(71) Applicant: Innomotics GmbH, 90441 Nümberg (DE)

(72) Inventor: Thomas CEPEK, Berlin (DE)

(73) Assignee: Innomotics GmbH, 90441 Nümberg (DE)

(21) Appl. No.: 18/695,549

(22) PCT Filed: Sep. 30, 2022
(86) PCT No.: PCT/EP2022/077335

§ 371 Date: Mar. 26, 2024

(30) Foreign Application Priority Data
Sep. 30, 2021 (EP) 21200238.0

(51) Int. Cl. H02K 5/16; H02K 1/18

(52) U.S. Cl. CPC H02K 5/16; H02K 1/18

(57) ABSTRACT

An electric machine includes a housing and a stator. The housing includes a double-walled bearing receptacle for receiving a bearing. A segmented ring adapter fastens the bearing to the housing. The electric machine has, in addition to the stator, a first stator-side coupling element and the housing has a first housing-side coupling element, wherein the first stator-side coupling element and the first housing-side coupling element are located at an axial height of the electrical machine in a region of a stator laminated core of the stator.

The invention relates to an electric machine. The electric machine has one housing, the machine housing.

An electric machine is for example a motor or a generator. Electric machines can be synchronous machines or asynchronous machines. The electric machine has electric conductors in an active part. The active part is for example a stator or an armature of the electric machine. The armature of the electric machine can for example also have permanent magnets and thus in particular a passive part. The stator of the electric machine has electrical conductors. The stator of the electric machine is in a housing of the electric machine. The armature of the electric machine is rotatably mounted by means of bearings. The bearing or bearings are accommodated in the housing of the electric machine.

In an electric machine, main assemblies must be connected to one another such that desired operating parameters can be safely achieved. Main assemblies of an electric machine are for example the stator, the armature, the housing and the bearings. In an electric machine the stator can be welded into the machine housing, as a result of which vibrations and structure-borne sound can be transmitted to the housing structure. If the machine housing is fastened to an installation, vibration dampers can be fitted under the feet of the machine housing so that the machine housing and the stator, which is rigidly connected to the machine housing, are somewhat decoupled from the rest of the installation.

Connection of main assemblies in this case relates to the coupling, i.e. the connection of stator and machine housing (housing of the electric machine). Static or dynamic forces are transmitted from the stator to the machine housing or vice versa via this connection, which represents a coupling of stator and housing. Furthermore, the coupling must also ensure the precise alignment of the stator to the machine housing. Since on the machine housing the rotor axis is also aligned to the machine housing via the bearing receptacles and bearings, the coupling of stator and machine housing thus also has an influence on the alignment of stator and rotor. The rotor can also be referred to as armature. The coupling of stator and machine housing is in particular a basis for effective operation of the electric machine in connection with the required operating parameters. Possible operating parameters in this case for example relate to vibrations, a rigidity, an imbalance and/or an axial alignment of the armature. In accordance with applicable international and/or national standards, electric machines must in particular comply with verified vibration values during operation. This results in particular in certain requirements for the rigidity of the machine housing and in particular of the bearing receptacle integrated therein.

One object of the invention is to improve the connection between main assemblies of the electric machine. This advantageously for example relates to the improvement of the vibration properties of the electric machine.

The object is achieved for example with an electric machine as claimed in claim 1. Further embodiments are achieved for example in accordance with claims 2 to 14.

In an electric machine the housing of the electric machine has a bearing receptacle which in particular is double-walled. A double-walled bearing receptacle is in particular advantageous for a vibration-critical electric machine. The electric machine further has segmented ring adapters for fastening the bearing to the housing. A plurality of segmented ring adapters (in other words at least two segments) form a ring. With the help of this ring, bearings of different sizes can be screwed to the housing. With the same size of opening of the housing to accommodate the bearings, bearings of different sizes and/or different types can then

be attached, if these provide for differently dimensioned fastening options. In one embodiment the segmented ring adapters have a gradation, in particular an internal gradation and/or an external gradation. This for example makes it possible for the axial length of the electric machine not to be increased unnecessarily despite adapters.

Machine housings can also be made with a thick steel plate in the region of the bearing receptacle, these for example additionally being provided with several reinforcing ribs on the inside. However, a thick steel plate for the bearing receptacle means that the housing is very heavy. A further disadvantage of just one heavy and thick steel plate for the bearing receptacle of the bearing or bearings of the electric machine can be that even with the reinforcing ribs it is not always possible to ensure compliance with the required vibration values. If necessary, further additional reinforcements must be applied after testing the machine. These problems can be prevented by a double-walled bearing receptacle. Both the walls of the bearing receptacle are in particular spaced apart at a distance corresponding to the axial extension of the bearing.

In one embodiment of the electric machine the double-walled bearing receptacle has at least two walls. A double-walled bearing receptacle can therefore also have three or more walls, since it has at least two walls. Such bearing receptacles with two or more walls can also be referred to as multi-walled bearing receptacles. Due to the double-walled bearing receptacle the rigidity of the bearing receptacle can be increased. Thus due to this advantageous design of the bearing receptacle, the additional use of material can in particular be kept within limits.

In one embodiment of the electric machine there is a reinforcement between the first wall and the second wall of the double-walled bearing receptacle. This increases the stability. In one embodiment of the electric machine the reinforcement has a plurality of ribs. Due to this too, the rigidity can be increased. In a further embodiment of the electric machine the reinforcement has a plurality of plates. The plates are firmly connected between the walls and to these walls. This too can improve and influence the rigidity.

In one embodiment of the electric machine the bearing is connected to just one wall of the double-walled bearing receptacle. This connection is in particular rigid. The wall is in particular in each case the end-face wall. Due to the double-walled design of the bearing receptacle there is an increase in rigidity even for just one wall.

In one embodiment of the electric machine it has a housing and a stator, wherein the stator has a first stator-side coupling element and the housing has a first housing-side coupling element, wherein the first stator-side coupling element and the first housing-side coupling element are at an axial height of the electric machine and wherein the first stator-side coupling element and the first housing-side coupling element are in the region of the stator laminated core. The axial height in this case relates to the position of the axis of rotation of the rotor of the electric machine. In this case in particular the position in respect of a distance from a plane to which the electric machine can be fastened must be taken into consideration. The region of the stator laminated core relates in particular to a region between end plates of the stator laminated core. The end plates are in each case on the end-face side of the stator laminated core. The region also relates to a position along a longitudinal alignment of the electric machine, in other words along the axis of rotation. The electric machine in particular has four connections between coupling elements. In this case the housing in particular has four housing-side coupling elements. The stator in particular has at least two or even four or more stator-side coupling elements. A stator-side coupling element for example has two connections, wherein in each case one of the connections represents a connection to a housing-side coupling element. Two connections between the coupling elements are in particular mirror-symmetrical to the axis of rotation of the electric machine. Due to one of the variants, described above or below, of the connection between stator and housing of the electric machine, this results in an advantageous coupling of stator and machine housing (housing) in electric machines. Thus for example it is possible to avoid setting up stators in the machine housing in such a way that the use of intermediate plates is necessary, wherein the stator can be aligned using intermediate plates and fastened in the machine housing with screws. The fastening was carried out in this case in a vertical alignment to the rotor axis. This would require additional components on the stator. On the one hand, these would where appropriate mean that the flow of force may be less favorable and, on the other hand, that vibration excitations from the stator into the machine housing may occur. Furthermore, additional components such as intermediate plates can result in the need for additional handling devices in the manufacturing process. By coupling stator and housing by means of stator-side and housing-side coupling elements the flow of force from the stator to the machine housing can be optimized. This also results in particular in what is known as a “decoupling” of the transmission of vibrations from the stator to the machine housing. In this case the coupling part of the stator transmits the vibrations of the stator during operation to the coupling part of the base frame of the housing.

In one embodiment of the electric machine the connection between the first stator-side coupling element and the first housing-side coupling element has screw connections. Such connections are easy to undo again. In a further embodiment, these can also for example be used instead of or in combination with connections or welded connections. The stator and machine housing are in particular coupled by a screw connection of stator and machine housing in a horizontal alignment to the rotor axis. The alignment is effected in this case for example due to one or more feather keys.

In one embodiment of the electric machine the connection between the first stator-side coupling element and the first housing-side coupling element thus in particular has a feather key, wherein in particular the stator is aligned to the housing by means of at least two feather keys. A feather key can for example be provided in each case for just one connection. In a further embodiment a feather key can be provided for at least two or more connections. A feather key for example extends only over the length of the respective connection. In a further embodiment a feather key for example extends from one connection to a second connection located in the axial direction. The axial direction in this case results from the direction or alignment of the axis of rotation of the electric machine. In one embodiment of the electric machine the stator-side coupling element has a groove to accommodate the feather key. Likewise, in one embodiment of the electric machine the housing-side coupling element also has a groove to accommodate the feather key. The stator-side coupling element is for example a rod with a rectangular profile, wherein the rod extends over the axial length of the stator. In this case the rectangular rod can be held in ring elements which are distributed over the axial length of the stator. In one embodiment of the connections between stator and housing with a feather key the transmission of forces and torques between stator and housing, in particular a base frame of the housing, can also be effected in particular via the feather key connection and not for example solely by a screw connection. By means of the feather key very high forces can be absorbed, which may for example occur in the event of a short-circuit. When feather keys are used, a groove for the feather key can for example in each case be made in the coupling parts of stator and base frame. The feather key at the same time also serves to produce a precise alignment of stator and base frame, in order in turn to ensure a precise alignment of stator and rotor. The screw connections to one another additionally present in the coupling parts serve to fix the connection and in particular not in every embodiment of the electric machine for the transmission of force and torque. Due to the use of feather keys, additional components for aligning the stator in the housing (thus in particular in the base frame of the housing) can be omitted and additional handling devices can also be saved in the manufacturing process.

In one embodiment of the electric machine the first housing-side coupling element and a second housing-side coupling element each have a connection to the first stator-side coupling element. As a result, a correct alignment of the stator can easily be achieved.

In one embodiment of the electric machine the first stator-side coupling element is accommodated in a ring element of the stator (a stator ring element). In particular, the stator-side coupling element is accommodated in a plurality of ring elements. This too facilitates the alignment of the stator.

In one embodiment of the electric machine the stator is fastened, in other words accommodated, in the housing by means of at least four connections between housing-side coupling elements and stator-side coupling elements, wherein due to a flat design the at least four connections span planes, wherein the axis of rotation of the electric machine is in a space between opposing planes. The axis of rotation is thus also located in the space that is spanned between the surfaces of the housing-side coupling elements. The axis of rotation thus runs at least partially through this spanned space. The connections are thus located at approximately the height of the axis of rotation of the electric machine. This increases the stability or rigidity of the fastening of the stator in the housing,

In one embodiment of the electric machine at least one housing-side coupling element is connected to a base point of the housing. The base point of the housing is in particular the region provided for fastening the electric machine to a foundation, for example. Because the housing-side coupling element is connected to the base point of the housing, the weight force of the stator can easily be conducted in this base point. The connection between housing-side coupling element and the base point of the housing is thus in particular effected directly. Due to this design of the coupling of stator and machine housing the flow of force from the stator to the machine housing is optimized. This also results in what is known as a “decoupling” of the transmission of vibration from the stator to the machine housing. In this case the coupling part of the stator (stator-side coupling element) transmits the vibrations of the stator during operation to the coupling part of the base frame (housing-side coupling element). Since this is in particular only fixed in the region of the connection of stator and base frame of the housing or in the base point on the base frame of the housing, it can act as a damping spring. So that the weight forces from the stator can be absorbed and the coupling part is supported on the base frame (housing-side coupling element), a stabilization part (stabilization element) is in particular connected by welding to the housing-side coupling element in the head and base point of this element.

In one embodiment of the electric machine it thus in particular has at least one housing-side coupling element with a stabilization element, wherein the stabilization element is connected to the housing-side coupling element. Both these elements are in particular attached perpendicularly to one another in order to increase the stability.

In one embodiment of the electric machine the housing has a base element and a cover element. Because the housing is segmented in this way, the stator can easily be incorporated in the housing. The base element is in this case provided to fasten the electric machine to a body, such as a foundation for example. The base element in particular has the housing-side coupling elements.

In respect of the rigidity of the housing and thus the vibration behavior of the electric machine, an advantageous connection can arise between various measures. A double-walled bearing receptacle can thus be advantageously combined with one of the variants of the use of coupling elements for fastening the stator in the housing. The axial position of coupling elements can also play a role here.

The invention is described and explained in greater detail below using the exemplary embodiments illustrated in the figures, in which:

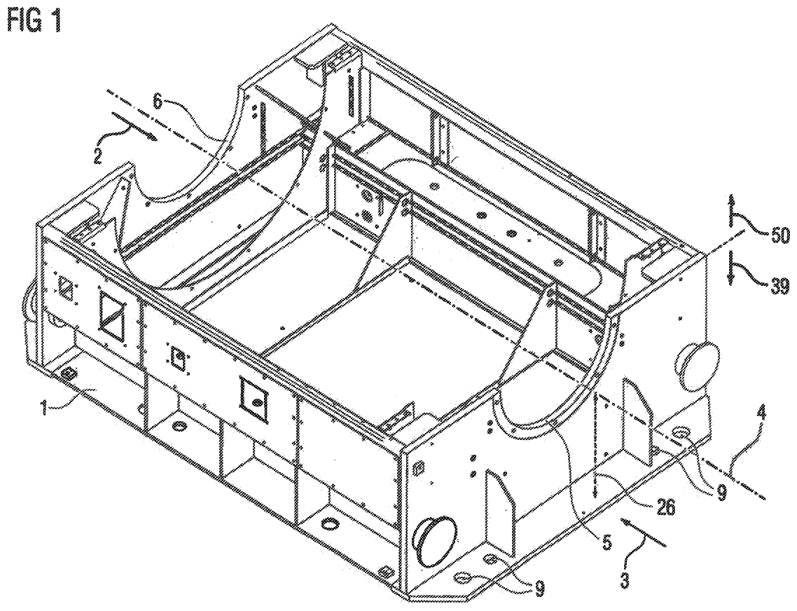

FIG. 1 shows a part of a housing of an electric machine,

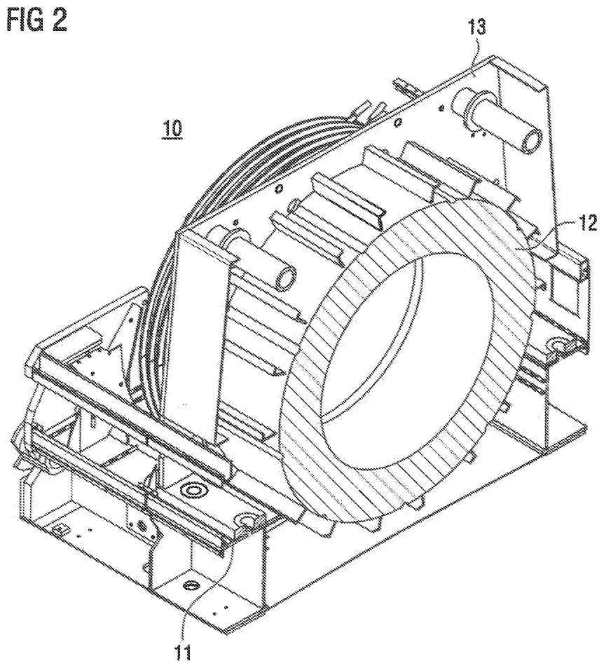

FIG. 2 shows an interface component of an electric machine,

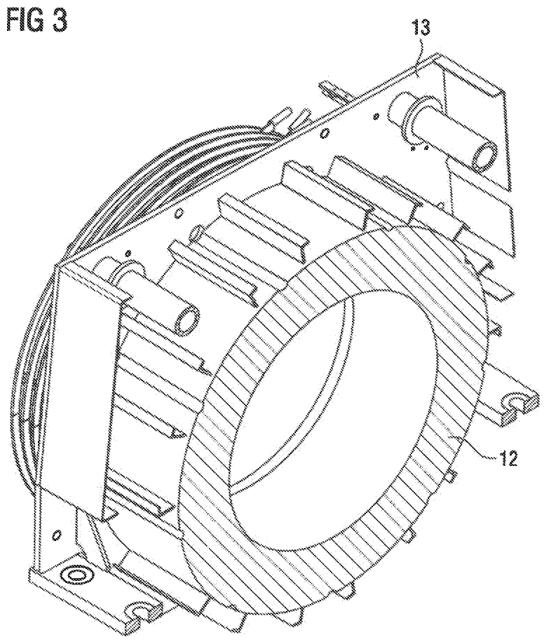

FIG. 3 shows a detailed view from FIG. 2,

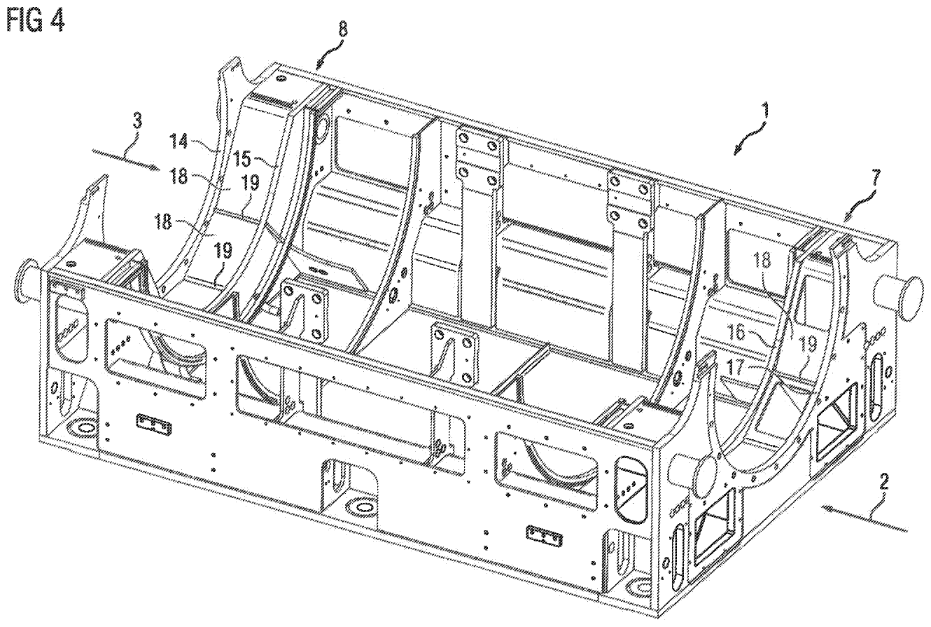

FIG. 4 shows a double-walled bearing receptacle,

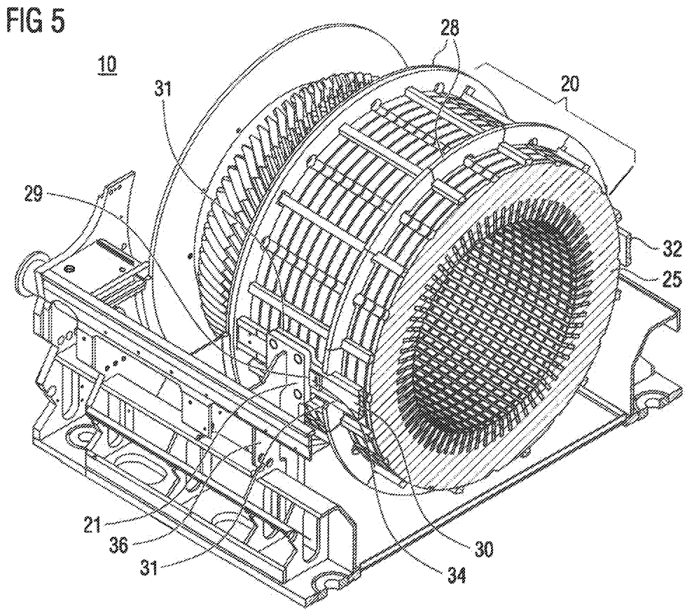

FIG. 5 shows a sectional illustration of the electric machine,

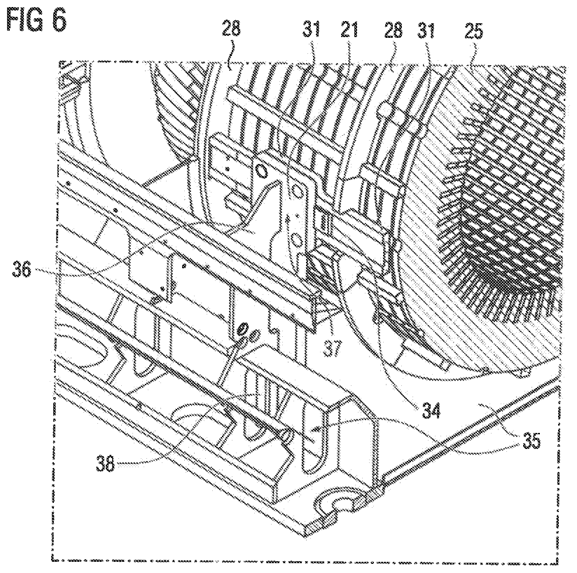

FIG. 6 shows a detailed view from FIG. 5,

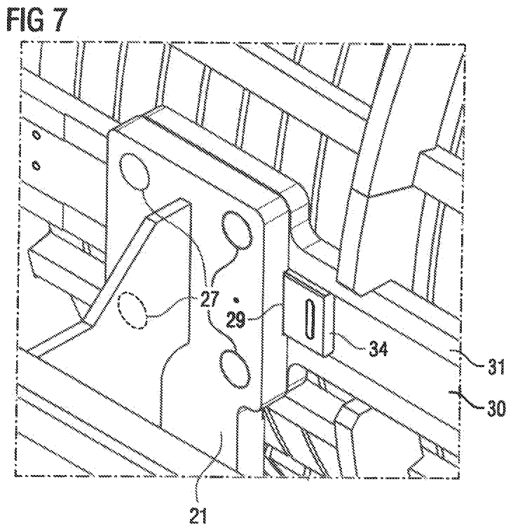

FIG. 7 shows a detailed view from FIG. 6, and

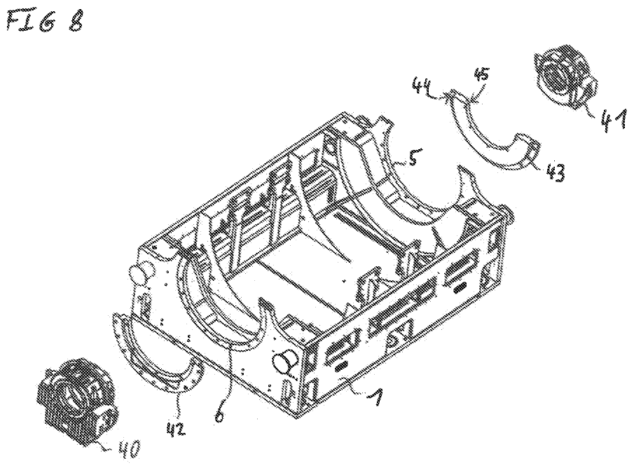

FIG. 8 shows a view with ring adapters.

The illustration in accordance with FIG. 1 shows part of a housing 1 of an electric machine. The housing has a first end face 2 and a second end face 3. The part of the housing 1 shown is, in a two-part housing, the base element in the region 39. Located in the region 40 is the cover element 40, wherein this cover element 40 is not illustrated in FIG. 1. The reaction axis 4 of the electric machine is located at an axial height 26. Further shown are a first bearing receptacle 5 and a second bearing receptacle 6. These are single-walled. This can be fastened by holes 9 in the region of the base point of the electric machine.

The illustration in accordance with FIG. 2 in turn shows a section of the electric machine, namely an interface component 11 in detail, by means of which a base frame 13 for the stator 12 is positioned.

The illustration in accordance with FIG. 3 shows a section from FIG. 2, focusing on the base frame 13 and stator 12. The illustration in accordance with FIG. 4 shows a double-walled bearing receptacle 7 and 8 with in each case a first wall 14 and 16 and in each case a second wall 15 and 17. The rigidity of the double-walled bearing receptacle 7 and 8 is reinforced by ribs 19 and plates 18. Due to the double-walled design of the bearing receptacle on the machine housing a significantly higher rigidity is achieved. The bearing receptacle thus prevents the bearings from having a greater tendency to vibrate as a result of excitation from the rotor or because of vibrations of the stator. This design makes it possible to make the bearing receptacle significantly more rigid due to two walls with an optimized material thickness and the reinforcing ribs located in between, without significantly increasing the weight of the housing. Alternatively, a bearing receptacle with a thicker bearing wall and additional thicker reinforcing ribs would be possible.

The illustration in accordance with FIG. 5 shows a sectional view of the electric machine 10. The stator has a stator laminated core 25. This is coupled to stator-side coupling elements 31, 32 via stator ring elements 28. The coupling elements 31, 32, 21 are located in the region of the stator laminated core 20. A housing-side coupling element 21 can be connected to the stator-side coupling element 31 via screw connections (four holes are illustrated for this; the screws are not illustrated). The first housing-side coupling element 21 is connected to a stabilization element 36. The coupling elements 21 and 31 have grooves 29 and 30 to accommodate a feather key 34.

The illustration in accordance with FIG. 6 shows the coupling in accordance with FIG. 5 in detail. Also shown is the base point 35 in relation to the housing 1 of the electric machine, and the base part 38 and the head part 37 of the housing-side coupling element 21 and thus also the head part and the base part of the stabilization element 36, which is connected in the head region and in the base region to the housing-side coupling element and stands perpendicular thereto.

The illustration in accordance with FIG. 7 shows a further detailed view of the coupling. In particular, it is shown how the feather key 34 fits into the grooves 29 and 30. Four holes 27 for screw connections are provided, only three being illustrated.

The illustration in accordance with FIG. 8 shows segmented ring adapters 42, 43 for fastening the bearings 40, 41 to the housing 1. A plurality of segmented ring adapters (in other words at least two segments) form a ring, which however is not shown in full. With the help of this ring, bearings of different sizes can be screwed to the housing. The segmented ring adapters 42, 43 have at least one gradation, in particular an internal gradation 44 and an external gradation 45. This for example makes it possible for the axial length of the electric machine not to be increased unnecessarily despite adapters. The internal gradation 44 for example engages in the receptacle 5, in other words is positioned therein. The bearing 41 engages in the external gradation 45 and is positioned therein. This enables a more compact design.

1-14. (canceled)

15. An electric machine, comprising:
a housing comprising a bearing receptacle for receiving a bearing; and
a segmented ring adapter designed to fasten the bearing to the housing.

16. The electric machine of claim 15, wherein the bearing receptacle is double-walled, the electric machine further comprising a reinforcement arranged between a first wall of the double-walled bearing receptacle and a second wall of the double-walled bearing receptacle.

17. The electric machine of claim 16, wherein the reinforcement comprises a plurality of ribs.

18. The electric machine of claim 16, wherein the reinforcement comprises a plurality of plates.

19. The electric machine of claim 16, wherein the bearing is rigidly connected to one of the first and second walls of the double-walled bearing receptacle.

20. The electric machine of claim 15, wherein the housing comprises a first housing-side coupling element, the electric machine further comprising a stator comprising a stator laminated core and a first stator-side coupling element, wherein the first stator-side coupling element and the first housing-side coupling element are located at an axial height of the electric machine in a region of the stator laminated core.

21. The electric machine of claim 20, further comprising screw connections designed to provide a connection between the first stator-side coupling element and the first housing-side coupling element.

22. The electric machine of claim 21, further comprising a feather key forming part of the connection between the first stator-side coupling element and the first housing-side coupling element.

23. The electric machine of claim 22, wherein the stator is aligned to the housing via at least two of said feather key.

24. The electric machine of claim 20, wherein the housing comprises a second housing-side coupling element, each of the first housing-side coupling element and the second housing-side coupling element comprising a connection to the first stator-side coupling element.

25. The electric machine of claim 20, wherein the stator comprises stator ring elements, the first stator-side coupling element being accommodated in the stator ring elements.

26. The electric machine of claim 20, comprising at least four of said housing-side coupling element, wherein the stator is fastened by at least four connections between the at least four housing-side coupling elements and stator-side coupling elements in the housing, wherein the at least four connections have a flat configuration to span planes, with an axis of rotation of the electric machine lying in a space between planes in opposition to one another.

27. The electric machine of claim 26, wherein at least one of the housing-side coupling elements is connected to a base point of the housing.

28. The electric machine of claim 26, wherein at least one of the housing-side coupling elements is connected to a stabilization element.

29. The electric machine of claim 15, wherein the housing comprises a base element and a cover element connectable to the base element.
